(19) United States
(12) Patent Application Publication
(10) Pub. No.: US 2008/0284132 A1
(43) Pub. Date: Nov. 20, 2008

(54) Covering for a fifth wheel load plate and kingpin of a transport trailer to prevent messing an antitheft locking device that surrounds the covering on the kingpin

(76) Inventors: Edmund R. Kirkland, Lumberton, NC (US); Denton E. Howard, Fairmont, NC (US)

Correspondence Address: Melvin L. Crane, 318 South Cleveland Street, Arlington, VA, 22204-2038, US

(21) Appl. No.: 11/803,414

(22) Filed: May 15, 2007

(51) Int. Cl. B62D 53/08

(52) U.S. Cl. 280/433

(57) ABSTRACT

A light-weight plastic protective covering for a kingpin of a transport trailer which prevents grease from adhering to or sticking to the locking device added to the kingpin to prevent stealing the transport trailer when it is decoupled from a road tractor. The protective covering is placed over the kingpin and the antitheft locking device is placed over the protective covering and secured to the kingpin on the outside of the protective covering.

### BACKGROUND OF THE INVENTION

It is well known in the trucking industry that the transport trailer (eighteen wheelers) is connected to a fifth wheel of a road tractor for delivering different products. The road tractor is provided with a fifth wheel which is a strong table on the rear portion of the tractor that tilts forward and often the table includes a fixed heavy load-bearing plate that tilts with the table. The load-bearing plate includes a slot which extends from a center of the plate aft and a kingpin extending downward from a metal plate on the front-center of the trailer is connected with the fifth wheel of the tractor by a locking device connected to the tractor which connects with the kingpin on the trailer in order to pull the trailer. The kingpin is secured to a heavy-duty load plate located beneath the front end of the trailer with a center line on a longitudinal center line of the trailer. The kingpin extends downwardly perpendicular with the load plate. The heavy load-bearing plate on the tractor is covered with grease before connecting with the kingpin.

The road tractor backs with the fifth wheel on the load plate under the front end of the trailer so that the heavy-duty load bearing plate on the tractor slides along the load plate on the trailer so that the kingpin passes along the rearward extending slot in the load-bearing plate. Once the kingpin is in place the kingpin is locked in place by a load-locking device on the tractor. The load-bearing plate is provided with a lot of grease so the trailer can easily rotate relative to the load-bearing plate as the tractor turns. When connected to the tractor, the load plate on the trailer rests on the load-bearing plate on the tractor to support the front end of the trailer on the fifth wheel of the tractor. The aft end of the slot in the load-bearing plate is “V” shaped to permit the kingpin to enter the slot more easily.

It is well known that when a trailer is disconnected from the tractor an antitheft device must be secured to the kingpin to prevent someone from connecting a tractor to the kingpin and hauling the trailer away. Before the trailer is connected to the tractor, a lot of grease is spread onto the load-bearing plate and the kingpin so that movement between the load plate on the trailer and the load-bearing plate on the tractor move relative to each other more easily.

When the trailer has been disconnected from the tractor, the load plate and kingpin are naturally covered with grease. In order to prevent someone from stealing the trailer, it is necessary to secure an antitheft device onto the kingpin. Since a lot of grease is on the load plate and kingpin the antitheft device becomes very greasy so that when the antitheft device is removed the operator gets very greasy. The greasy antitheft device is wrapped and placed in a container on the tractor for future use.

In order to prevent the antitheft device from becoming greasy after being installed on the kingpin, applicant's protective covering is placed onto the kingpin and the antitheft device is connected to the kingpin on the outside of the protective covering. Since the antitheft device is on the outside of the protective covering, no grease will adhere to the antitheft device. Thus, the antitheft device can be handled without becoming all greasy and can be placed in a container on the tractor without lot of grease so long as the antitheft device is connected to the kingpin such that a road tractor with a fifth wheel when backed under the front end of the trailer cannot be connected to the kingpin.

### SUMMARY OF THE INVENTION

The real purpose of the cover device is to protect a person from the grease on the kingpin and surrounding area after the tractor has been disconnected from the fifth wheel. The disk of the cover device prevents the grease on the heavy metal plate on the trailer from adhering to a person servicing the kingpin. The covering device on the pressure plate of the trailer and kingpin prevents grease from adhering onto the antitheft device which is connected to the kingpin on the outside surface of the cylindrical cylinder. Prior to use of a protective covering device, such as set forth herein, the antitheft device is connected directly to an annular groove in the kingpin so that grease on the kingpin can adhere to the antitheft device. Thus, when an operator desires to hook onto a trailer kingpin, the greasy antitheft device must be handled with all the grease thereon. The antitheft device is then placed into a protective covering and placed into the tractor storage compartment until needed again.

It would be obvious to one skilled in the art that the protective covering device can be placed onto the kingpin so that the disk is under the load plate on the trailer and the cylindrical portion of the protective covering will cover the kingpin. The antitheft device is then connected to the kingpin on the outside of the protective cover.

### BRIEF DESCRIPTION OF THE DRAWING

FIG. 1 illustrates a top view of the protective covering;

FIG. 2 illustrates a cross section view along lines 2-2 of FIG. 1;

FIG. 3 is a perspective view of the back side of the protective covering;

FIG. 4 illustrates a side view of the protective covering;

FIG. 5 illustrates a side view of the load plate on the trailer with the kingpin secured to the bottom surface of the load plate; and

FIG. 6 illustrates the protective covering on the kingpin with an antitheft device connected to the kingpin from an outside of a cylindrical portion of the protective device.

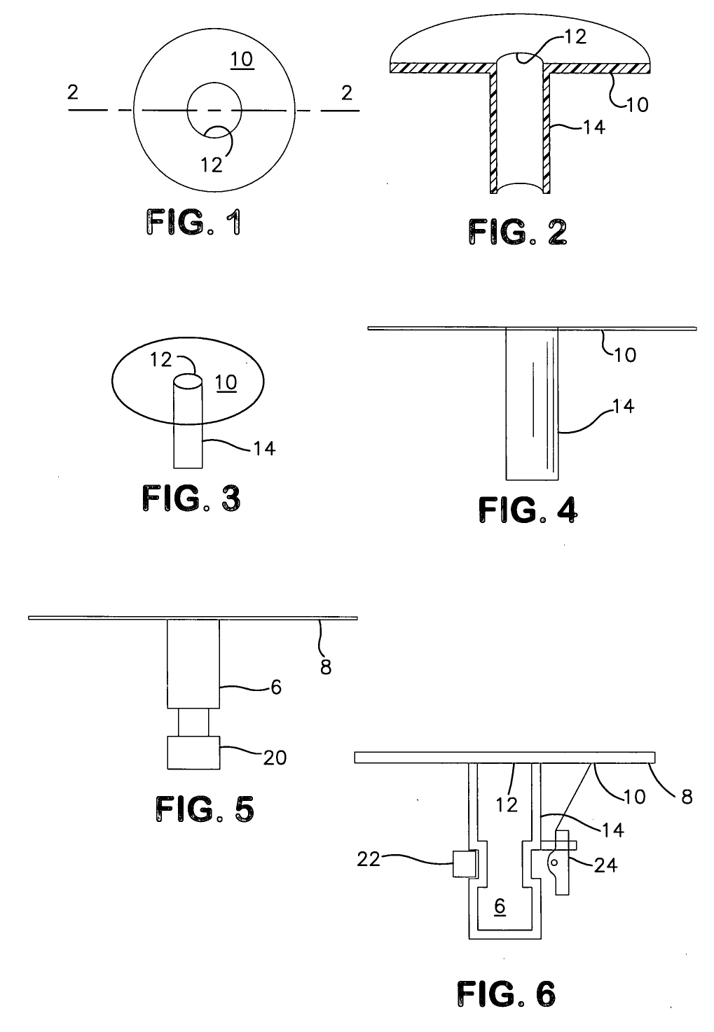

### DETAILED DESCRIPTION

Now referring to the drawing which illustrates a protective covering device for a kingpin (6) that protrudes from a bottom surface of a heavy metal pressure plate (8) secured to the underside front-central position of a trailer, not shown. As shown throughout the drawing, the protective covering device includes an upper thin circular disk (10) having a diameter substantially that of a locking device of the trailer. The plate (10) has an aperture (12) at the center of the disk from which a cylinder (14) extends. The disk can be made of any desired material such as a semi-rigid plastic sheet having a thickness of from about six mil to about 10 mil in which the aperture (12) is of sufficient diameter to connect the cylinder to the aperture of the disk. The cylinder has an inside diameter which is sufficient to extend over the kingpin and has a length to extend from the metal plate (8) to about one inch below the end of the cylinder and can be made from a sheet of pliable plastic formed into a cylindrical tubular element. The upper end of the cylinder can be flared to be secured to a matching surface of the aperture (12). The cylinder can be formed from a pliable plastic material having a thickness of from about two mil to about six mil of a diameter and a length sufficiently long to fit over the length of the kingpin and secured at its upper end to the metal plates (8). The cylinder may be closed or open at the lower end of the kingpin; however, to prevent grease from falling from the bottom of the cylinder, it is referred to be closed so that the end is covered. The length of the cylinder should be sufficient for the disk to be close to or covering the bottom surface of the heavy metal load plate (8) on the trailer.

The upper end of the cylinder can be flared, beveled or any other shape which is connected to be a matching configuration of the aperture to which the upper end of the cylinder is connected. The disk to which the upper end of the cylinder is connected has an area which is sufficient to cover the top surface of the locking device plus approximately 2 or more inches.

The cylinder (14) must be formed of a pliable clear plastic so that an antitheft locking device secured over the outside of the protective covering will deform the cylinder in the area of a circular groove (20) in the kingpin such that the antitheft device can be secured to the kingpin via the protective covering. The kingpin is provided with the circular groove (20) to which the antitheft device (22) is connected and to which a locking device, not shown, is secured when the kingpin on the trailer is connected to the tractor. The kingpin is the only thing used to pull the trailer when connected to the tractor.

FIG. 6 illustrates a protective covering device as used on a kingpin of a trailer. The protective covering is slid over the kingpin (6) such that the disk (10) of the protective covering is in contact with or close to the under side of the heavy metal plate (8) on the trailer. The cylinder of the protective covering will cover the length of the kingpin. Once the protective covering is in place, the antitheft device can be secured in place. The antitheft device fits over the protective covering in the vicinity of the cylindrical groove in the kingpin. The antitheft device deforms the cylinder of the protective covering in the vicinity of the groove in the kingpin. When securing the antitheft device to the kingpin, the antitheft device secures the protective covering onto the kingpin. When the antitheft device is removed from the kingpin, the protective covering can also be removed from the kingpin.

The protective covering prevents the grease from transferring from the heavy metal plate on the trailer and the kingpin suspended from the heavy metal plate. The antitheft device is, therefore, clear of grease.

The protective device set forth herein can be used over and over again for a trailer after the trailer is disconnected from a fifth wheel of a tractor. In use, grease is prevented from sticking onto the antitheft device so that an operator does not get greasy from handling the antilock device when connecting with a transport trailer.

What is claimed is:

1. A protective covering device for an underside surface of a heavy metal plate and a kingpin of an eighteen wheeler transport trailer that is disconnected from a fifth wheel of a tractor; which comprises a flat surface disk (10) having a dimension substantially that of an anti-theft locking device, a circular aperture (12) in said disk, an elongated cylindrical cylinder (14) having an open upper end and depending from said circular aperture (12) in said disk (10) and connected thereto at the open upper end of the cylinder, said cylinder having a diameter and length slightly larger than that of said kingpin.

2. A device as set forth in claim 1 in which said cylinder is of any pliable material and said disk is of a semi-rigid or rigid material.

3. A device as set forth in claim 2 in which said disk is made of any appropriate flat surface material.

4. A device as set forth in claim 1 in which said aperture in said disk is beveled toward an axis of the aperture, and said upper end of said cylindrical cylinder includes a beveled end portion that joins with said beveled surface of said aperture.

5. A device, as set forth in claim 4, in which said aperture in said disk is at a center of the disk.

6. A device as set forth in claim 2 in which said pliable material is transparent or opaque.

7. A device as set forth in claim 1 in which said cylinder is of a transparent or opaque material.
